(19) United States
(12) Patent Application Publication
(10) Pub. No.: US 2021/0117987 A1
(43) Pub. Date: Apr. 22, 2021

(54) FRAUD ESTIMATION SYSTEM, FRAUD ESTIMATION METHOD AND PROGRAM

(71) Applicant: Rakuten, Inc., Tokyo (JP)

(72) Inventor: Mitsuru NAKAZAWA, Setagaya-ku, Tokyo (JP)

(21) Appl. No.: 17/253,610

(22) PCT Filed: May 31, 2019
(86) PCT No.: PCT/JP2019/021771

§ 371 Date: Dec. 17, 2020

(51) Int. Cl. G06Q 30/00; G06K 9/00; G06Q 30/06; G06K 7/14

(52) U.S. Cl. CPC G06Q 30/0185; G06K 7/1447; G06Q 30/0627; G06K 9/00671

(57) ABSTRACT

Item information obtaining means of a fraud estimation system obtains item information about an item. Mark identification means identifies a mark on the item, based on the item information. Classification identification means identifies a classification of the item based on the item information. Estimation means estimates fraudulence concerning the item, based on the identified mark and the identified classification.

### TECHNICAL FIELD

The one embodiment of the present invention relates to a fraud estimation system, a fraud estimation method, and a program therefor.

### BACKGROUND ART

In recent years, the circulation of fraudulent items using marks of widely known brands or the like without permission has been an issue. A system in Patent Literature 1 has been known to estimate the fraudulence of an item by attaching a tag on which information about an item is recorded to the item and reading the information recorded on the tag.

### CITATION LIST

### Patent Literature

[PTL 1] JP 2013-214314 A

### SUMMARY OF INVENTION

### Technical Issue

With the technology of Patent Literature 1, however, the fraudulence of, for example, an item listed on the Internet cannot be estimated because a tag physically attached to an item is required to be read.

The one embodiment of the present invention has been made in view of the issue described above, and an object of the one embodiment of the present invention is to provide a fraud estimation system, a fraud estimation method, and a program therefor, which enable the estimation of fraud from information about an item without, for example, physically attaching a tag to the item and reading the tag.

### Solution to Issue

In order to solve the above-mentioned issues, according to one embodiment of the present invention, there is provided a fraud estimation system, including: item information obtaining means for obtaining item information about an item; mark identification means for identifying a mark on the item, based on the item information; classification identification means for identifying a classification of the item, based on the item information; and estimation means for estimating fraudulence concerning the item, based on the identified mark and the identified classification.

According to one embodiment of the present invention, there is provided a fraud estimation method including: an item information obtaining step of obtaining item information about an item; a mark identification step of identifying a mark on the item, based on the item information; a classification identification step of identifying a classification of the item, based on the item information; and an estimation step of estimating fraudulence concerning the item, based on the identified mark and the identified classification.

According to one embodiment of the present invention, there is provided a program for causing a computer function as: item information obtaining means for obtaining item information about an item; mark identification means for identifying a mark on the item, based on the item information; classification identification means for identifying a classification of the item, based on the item information; and estimation means for estimating fraudulence concerning the item, based on the identified mark and the identified classification.

According to one aspect of the present invention, the item information includes an item image in which the item is shown, and the mark identification means is configured to identify the mark on the item based on the item image.

According to one aspect of the present invention, the fraud estimation system further includes mark recognizer creation means for creating a mark recognizer, based on an image in which a mark to be recognized is shown, and the mark identification means is configured to identify the mark on the item, based on the item image and the mark recognizer.

According to one aspect of the present invention, the fraud estimation system further includes search means for searching the Internet for the image in which the mark to be recognized is shown, with the mark to be recognized as a query, and the mark recognizer creation means is configured to create the mark recognizer, based on the image that is found through the search.

According to one aspect of the present invention, the item information includes an item image in which the item is shown, and the classification identification means is configured to identify the classification of the item, based on the item image.

According to one aspect of the present invention, the fraud estimation system further includes classification recognizer creation means for creating a classification recognizer, based on an image in which a photographic subject of a classification to be recognized is shown, and the classification identification means is configured to identify the classification of the item, based on the item image and the classification recognizer.

According to one aspect of the present invention, the classification identification means is configured to identify the classification of the item from among a plurality of classifications defined in advance, and the classification recognizer creation means is configured to create the classification recognizer, based on the plurality of classifications.

According to one aspect of the present invention, the mark identification means is configured to identify the mark on the item, based on the item image, the fraud estimation system further includes position information obtaining means for obtaining position information about a position of the identified mark in the item image, and the classification identification means is configured to identify the classification of the item, based on the item image and the position information.

According to one aspect of the present invention, the classification identification means is configured to perform processing on a portion of the item image that is determined from the position information to identify the classification of the item, based on the image that has been subjected to the processing.

According to one aspect of the present invention, the fraud estimation system further includes feature amount calculator creation means for creating a feature amount calculator configured to calculate a feature amount of a word, and the estimation means is configured to estimate fraudulence concerning the item, based on a feature amount that is calculated for the identified mark by the feature amount calculator and a feature amount that is calculated for the identified classification by the feature amount calculator.

According to one aspect of the present invention, the feature amount calculator creation means is configured to create the feature amount calculator, based on description text of a legitimate item.

According to one aspect of the present invention, the fraud estimation system further includes association data obtaining means for obtaining association data, in which each of a plurality of marks is associated with at least one classification, and the estimation means is configured to estimate fraudulence concerning the item, based on the identified mark, the identified classification, and the association data.

According to one aspect of the present invention, the item is a product, the item information is product information about the product, the mark identification means is configured to identify a mark on the product, based on the product information, the classification identification means is configured to identify a classification of the product, based on the product information, and the estimation means is configured to estimate fraudulence concerning the product.

### Advantageous Effects of Invention

According to the one embodiment of the present invention, fraud can be estimated from information about an item without physically attaching a tag to the item and reading the tag.

### BRIEF DESCRIPTION OF DRAWINGS

FIG. 1 is a diagram for illustrating an overall configuration of a fraud estimation system.

FIG. 2 is a diagram for illustrating an item image of an authentic item.

FIG. 3 is a diagram for illustrating an item image of a fraudulent item.

FIG. 4 is a function block diagram for illustrating an example of functions implemented in the fraud estimation system.

FIG. 5 is a table for showing a data storage example of an item database.

FIG. 6 is a table for showing a data storage example of a mark image database.

FIG. 7 is a table for showing a data storage example of a classification image database.

FIG. 8 is a diagram for illustrating how processing is performed on a mark portion of an item image.

FIG. 9 is a flow chart for illustrating an example of preliminary processing.

FIG. 10 is a flow chart for illustrating an example of estimation processing.

FIG. 11 is a function block diagram in Modification Example (1).

FIG. 12 is a table for showing a data storage example of association data.

### DESCRIPTION OF EMBODIMENTS

### 1. Overall Configuration of Fraud Estimation System

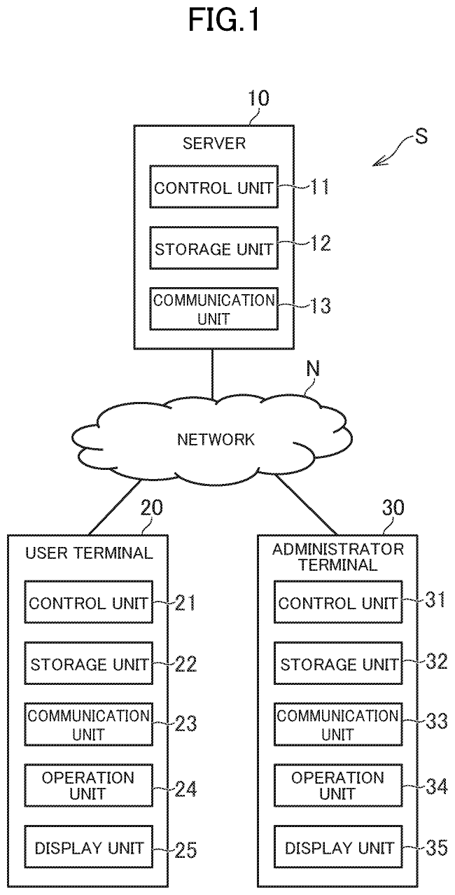

An example of a fraud estimation system according to an embodiment of the present invention is described below. FIG. 1 is a diagram for illustrating an overall configuration of the fraud estimation system. As illustrated in FIG. 1, a fraud estimation system S includes a server 10, a user terminal 20, and an administrator terminal 30, which can be connected to the Internet or a similar network N. Although one server 10, one user terminal 20, and one administrator terminal 30 are illustrated in FIG. 1, the fraud estimation system S may include a plurality of servers 10, a plurality of user terminals 20, and a plurality of administrator terminals 30.

The server 10 is a server computer. The server 10 includes a control unit 11, a storage unit 12, and a communication unit 13. The control unit 11 includes at least one processor. The control unit 11 executes processing in accordance with a program and data that are stored in the storage unit 12. The storage unit 12 includes a main memory and an auxiliary memory. For example, the main memory is a RAM or a similar volatile memory, and the auxiliary memory is a ROM, an EEPROM, a flash memory, a hard disk drive, or a similar non-volatile memory. The communication unit 13 is a communication interface for cable communication or wireless communication, and holds data communication over the network N.

The user terminal 20 is a computer to be operated by a user. For example, the user terminal 20 is a cellular phone (including a smartphone), a portable information terminal (including a tablet computer), or a personal computer. In this embodiment, the user terminal 20 includes a control unit 21, a storage unit 22, a communication unit 23, an operation unit 24, and a display unit 25. The control unit 21, the storage unit 22, and the communication unit 23 may have the same physical configurations as those of the control unit 11, the storage unit 12, and the communication unit 13, respectively.

The operation unit 24 is an input device, for example, a pointing device, which is a touch panel, a mouse, or the like, a keyboard, or a button. The operation unit 24 transmits what operation has been performed by the user to the control unit 21. The display unit 25 is, for example, a liquid crystal display unit or an organic EL display unit. The display unit 25 displays an image following an instruction of the control unit 21.

The administrator terminal 30 is a computer to be operated by an administrator. For example, the administrator terminal 30 is a cellular phone (including a smart phone), a portable information terminal (including a tablet computer), or a personal computer. In this embodiment, the administrator terminal 30 includes a control unit 31, a storage unit 32, a communication unit 33, an operation unit 34, and a display unit 35. The control unit 31, the storage unit 32, the communication unit 33, the operation unit 34, and the display unit 35 may have the same physical configurations as those of the control unit 21, the storage unit 22, the communication unit 23, the operation unit 24, and the display unit 25, respectively.

Programs and data described as ones to be stored in the storage units 12, 22, and 32 may be supplied via the network N. The hardware configurations of the computers described above are not limited to the examples given above, and may employ various types of hardware. For instance, the computers may include a reading unit (for example, an optical disc drive or a memory card slot) configured to read a computer-readable information storage medium, and an input/output unit (for example, a USB port) for data input/output to/from an external device. For example, a program or data stored in an information storage medium may be supplied to the computers via the reading unit or the input/output unit.

### 2. Outline of Fraud Estimation System

In this embodiment, processing of the fraud estimation system S is described by taking as an example a scene in which the user operates the user terminal 20 to post on a social network, a bulletin board, or the like. The server 10 receives a given request from the administrator terminal 30, then analyzes an item image included in the user's post to identify a mark on an item and the classification of the item, and uses the combination of the mark and the classification to estimate fraudulence concerning the item.

The term “item image” means an image in which an item is shown. In other words, an item image is an image in which an item is a photographic subject. An item is photographed in an item image. An item image may be a photographed image that is directly generated by a camera, or an image that is obtained by processing a photographed image. In this embodiment, an item image of an item photographed by the user is uploaded to the server 10.

The term “item” means an object to which a mark is affixed. In other words, an item is a photographic subject in an item image. An item may be an object of commercial transaction, or may not particularly be an object of commercial transaction. An item may be any object, for example, an article of clothing, food, a piece of furniture, a home electrical appliance, a writing material, a toy, a sundry article, or a vehicle. An item may have a mark printed directly thereon, or an object such as a sticker or a piece of cloth on which a mark is printed may be attached to an item. An item is not limited to a tangible object, and may be an image, a moving image, or other intangible objects.

The term “mark” means identification information of an item. A mark may be referred to as “logo” or “emblem”. For example, a mark includes a character string that is a product name, a manufacturer name, a seller name, a brand name, a store name, an affiliated-group name, or the like. To give another example, a mark includes a graphic that indicates a product, a manufacturer, a seller, a brand, a store, an affiliated group, or the like. A mark is not limited to characters and graphics, and may be, for example, a symbol, a three-dimensional figure, a color, or a sound, or may be a combination thereof. A mark may be shown in a planar manner or may be shown three-dimensionally. A mark may not particularly change in appearance, or may change in appearance. For instance, a mark may be like a moving picture, of which appearance changes with the passage of time, or a hologram, of which appearance varies depending on angle.

The term “classification” means information indicating the type or properties of an item. A classification may be referred to as “genre”, “category”, “label”, “class”, or “attribute”. It is sufficient to define classifications based on item usage or other criteria and, for example, an item belongs to at least one of a plurality of classifications defined in advance. An item may belong to only one classification, or a plurality of classifications. The classifications may be defined hierarchically or may not particularly be hierarchized.

Fraudulence concerning an item means a questionable combination of an item's mark and classification. In other words, fraudulence concerning an item means a combination of a mark and a classification that is inconceivable for an item provided by a genuinely entitled entity. For example, the affixing of a mark of an entitled entity who has the right to use the mark to an item having a classification under which the entitled entity does not manufacture or does not license an item qualifies as fraudulence concerning an item. In other words, the affixing of the mark to an item having a classification different from the classification of an authentic item qualifies as fraudulence concerning an item.

Estimation of fraudulence concerning an item may mean estimating that the combination of an item's mark and classification is questionable (for example, processing up through determination of whether the combination of an item's mark and classification is questionable, not including output to indicate whether the item is fraudulent), or may mean estimation including estimating whether an item is fraudulent.

A user may post a word-of-mouth review or the like of an authentic item, and may purchase a counterfeit product (pirated product) or a fraudulent item of other kinds and post a word-of-mouth review or the like. A post about a fraudulent item has the possibility of disbenefiting the genuinely entitled entity of the mark or giving wrong information to other users. The server 10 therefore estimates whether an item is authentic or fraudulent by analyzing an item image.

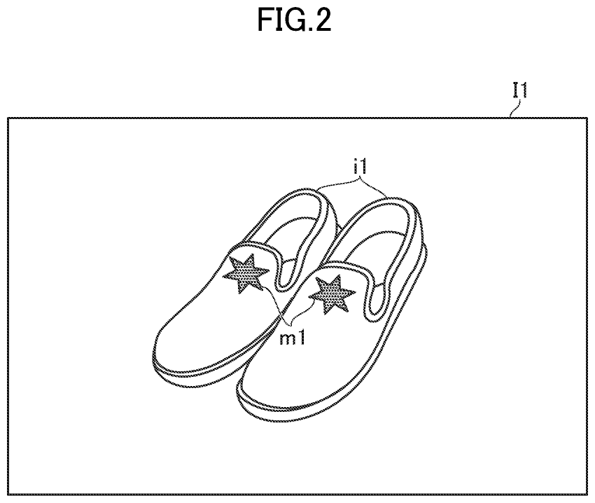

FIG. 2 is a diagram for illustrating an item image of an authentic item. The description given here takes as an example a case in which a shoe manufacturer sells shoes of its brand with a star-shaped mark m1 affixed to the shoes. The server 10 analyzes an item image I1 posted by a user to identify the mark m1 affixed to an item i1 and the classification (here, shoes) of the item i1. A method of identifying the mark and the classification is described later. In the example of FIG. 2, the mark m1 of the shoe manufacturer is affixed to a pair of shoes sold by the shoe manufacturer, and the combination of the mark and the item is therefore a reasonable (proper) combination. The server 10 accordingly estimates that the item i1 is not a fraudulent item and is an authentic item.

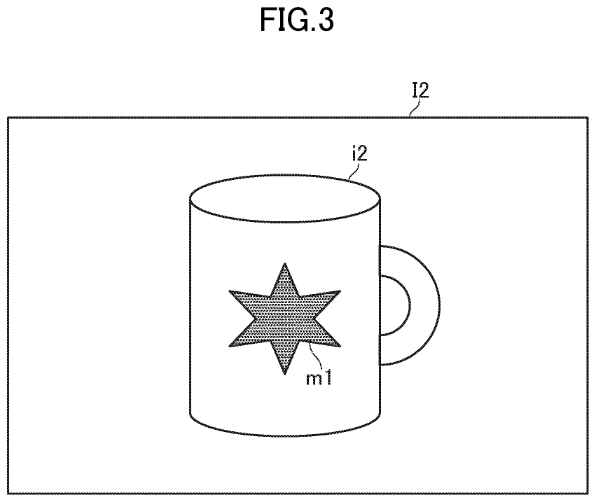

FIG. 3 is a diagram for illustrating an item image of a fraudulent item. It is assumed here that the shoe manufacturer does not sell, nor provide as a novelty or the like, a mug to which the mark m1 of its brand is affixed. The server 10 analyzes an item image I2 posted by a user to identify the mark m1 affixed to an item i2 and the classification (here, mug) of the item i2. The shoe manufacturer does not sell, nor provide as a novelty or the like, a mug with the mark m1 affixed thereto. Those are therefore a questionable combination, and the probability is high that the item is a counterfeit product or the like for which a malicious person has borrowed the mark without consent. The server 10 accordingly estimates that the item i1 is a fraudulent item.

The fraud estimation system S according to this embodiment thus identifies the mark and the classification by analyzing an item image. The fraud estimation system S estimates that the item shown in the item image is an authentic item when the combination of the mark and the classification is reasonable. When the combination of the mark and the classification is questionable, on the other hand, the fraud estimation system S estimates that the item shown in the item image is a fraudulent item. This saves the administrator the trouble of fraud estimation by way of visual determination of an item image. Details of the fraud estimation system S are described below.

### 3. Functions Implemented in Fraud Estimation System

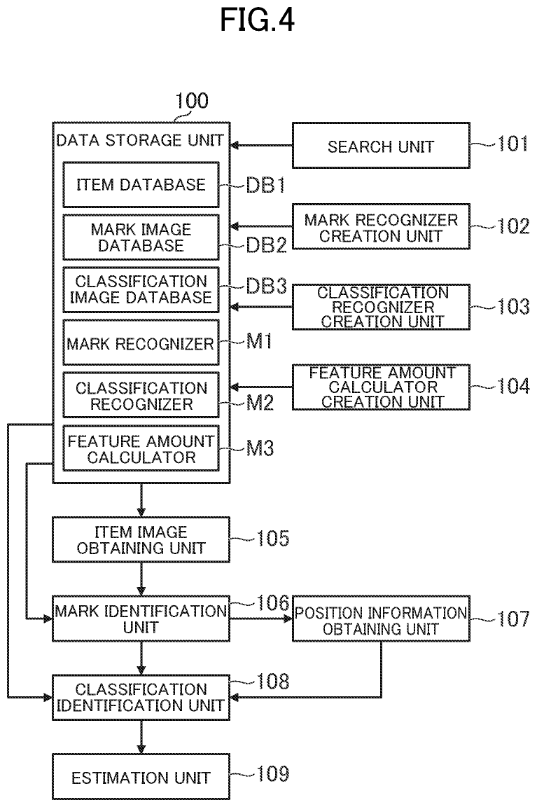

FIG. 4 is a function block diagram for illustrating an example of functions implemented in the fraud estimation system S. As illustrated in FIG. 4, a data storage unit 100, a search unit 101, a mark recognizer creation unit 102, a classification recognizer creation unit 103, a feature amount calculator creation unit 104, an item image obtaining unit 105, a mark identification unit 106, a position information obtaining unit 107, a classification identification unit 108, and an estimation unit 109 are implemented in the server 10.

[3-1. Data Storage Unit]

The data storage unit 100 is implemented mainly by the storage unit 12. The data storage unit 100 stores data that is required to execute processing described in this embodiment. As an example of the data to be stored in the data storage unit 100, an item database DB1, a mark image database DB2, and a classification image database DB3 are described here.

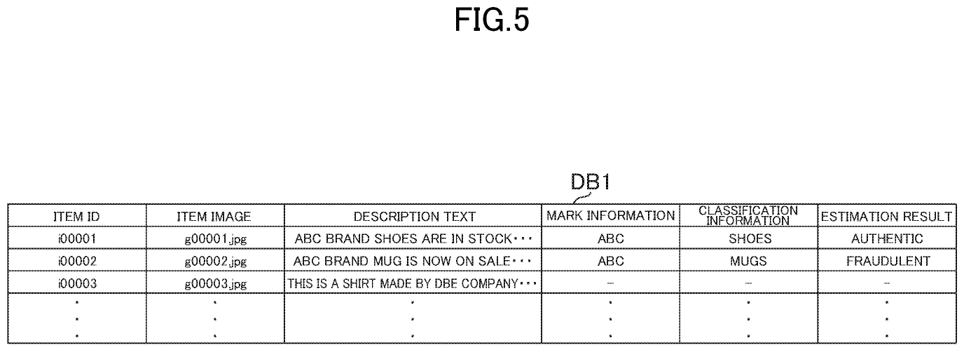

FIG. 5 is a table for showing a data storage example of the item database DB1. As shown in FIG. 5, the item database DB1 is a database storing information about an item that is a target of fraud estimation. The item database DB1 stores, for example, an item ID with which an item is uniquely identified, an uploaded item image, item description text, mark information with which a mark identified by the mark identification unit 106 is identified, classification information with which a classification identified by the classification identification unit 108 is identified, and an estimation result by the estimation unit 109.

The description text is writing about an item in which a feature or impression, for example, of the item is written. In this embodiment, a user has freedom to input any description text. The description text may also be fixed text selected by a user. The mark information is any type of information with which a mark on an item can be identified, and may be, for example, an ID for uniquely identifying the mark or a character string indicating the mark. Similarly, the classification information is any type of information with which the classification of an item can be identified, and may be, for example, an ID for uniquely identifying the classification or a character string indicating the classification. Not only the description text but also a chart, an image, and the like that each indicate a feature of an item may be stored in the item database DB1, and information specified for an item by a user as information for identifying a mark or a classification may be stored in the item database DB1.

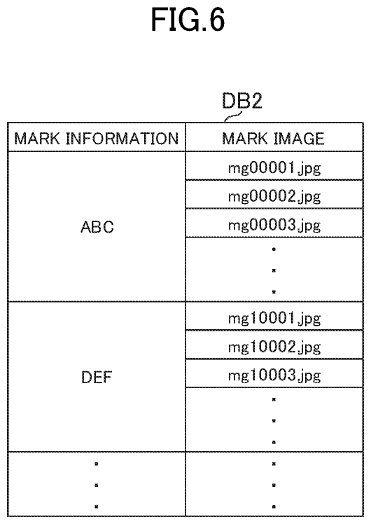

FIG. 6 is a table for showing a data storage example of the mark image database DB2. As shown in FIG. 6, the mark image database DB2 is a database storing a mark image, in which, for example, mark information and at least one mark image are stored. In this embodiment, a mark image is obtained through a Net search as described later, and the mark information may accordingly be a character string used as a query in the search or may be an ID converted from the character string.

The mark image is an image used to create a mark recognizer M1, which is described later. The mark image is, as a general rule, an image of an authentic item, but allows the mixing in of some images of fraudulent items. The mark image may be an item image stored in the item data base DB1, and may not particularly be an image stored in the item database DB1. In this embodiment, a mark image found through a search by the search unit 101, which is described later, is stored in the mark image database DB2. The mark recognizer M1 described later may learn with portions of the mark image other than the mark masked, inpainted, or otherwise processed, or may learn without particularly processing the portions of the mark image.

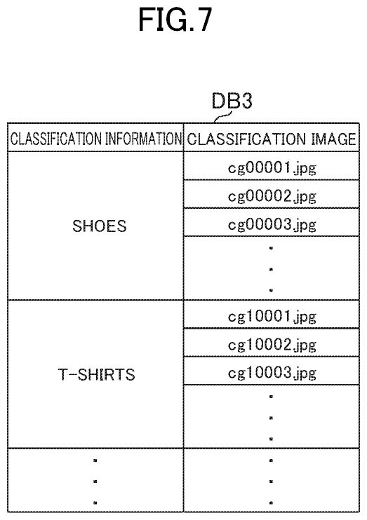

FIG. 7 is a table for showing a data storage example of a classification image database DB3. As shown in FIG. 7, the classification image database DB3 is a database storing a classification image. For example, at least one classification image is stored for each piece of classification information in the classification image database DB3.

The classification image is an image used to create a classification recognizer M2, which is described later. The classification image is an image used for learning the general shape of an object. In this embodiment, an item alone is shown in the classification image, without a mark. An item with a mark, however, may be shown in the classification image. In this case, the classification recognizer M2 described later may learn with the mark portion in the classification image masked, inpainted, or otherwise processed, or may learn without particularly processing the mark portion.

The classification image may be an item image stored in the item database DB1, or may not particularly be an image stored in the item database DB1. The classification image in a case described in this embodiment is an image downloaded from another system that provides images for a research purpose. However, the classification image may not particularly be an image downloaded from another system, and the administrator himself/herself may prepare the classification image.

Data stored in the data storage unit 100 is not limited to the example given above. For instance, the data storage unit 100 stores the mark recognizer M1 for recognizing a mark. The mark recognizer M1 includes, among others, a program (an algorithm) and a parameter and, in this embodiment, is described by taking as an example a machine learning model that is used in image recognition. Various known methods can be employed for the machine learning itself and, for example, a convolutional neural network (CNN), a residual network (ResNet), or a recurrent neural network (RNN) may be used. The mark recognizer M1 receives input of an item image or a feature amount thereof and, in response, outputs a mark in the item image and position information about the position of the mark. The mark recognizer M1 may not particularly output mark position information.

Other than the example given above, the mark recognizer M1 may use, for example, a method called CAM, YOLO, or SSD. According to those methods, the result of mark recognition and information (for example, a heat map) about a portion on which attention is focused in the recognition can both be output. For example, when the position (bounding box, for example) of the mark in the image is annotated, the use of YOLO or SSD enables the detection of not only the mark but also the position of the mark. To give another example, when a method called Grad-CAM is used separately from the mark recognizer M1, information (for example, a heatmap) about a portion on which attention is focused by the mark recognizer M1 in mark recognition is output and a rough position of the mark can therefore be estimated even without the mark position being annotated.

Another example of data stored in the data storage unit is the classification recognizer M2. The classification recognizer M2 includes, among others, a program (an algorithm) and a parameter and, in this embodiment, is described by taking as an example a machine learning model that is used in image recognition. Similarly to the mark recognizer M1, the classification recognizer M2 can employ various known methods for the machine learning itself. For example, CNN, ResNet, RNN, or a similar method may be used for the classification recognizer M2 as well. The classification recognizer M2 receives input of an item image or a feature amount thereof and, in response, outputs the classification of an item shown in the item image.

Still another example of data stored in the data storage unit is a feature amount calculator M3. The feature amount calculator M3 includes, among others, a program (an algorithm), a parameter, and dictionary data for converting a word into a feature amount and, in this embodiment, is described by taking as an example a machine learning model that is used in natural language processing. Similarly to the mark recognizer M1 and the classification recognizer M2, various known methods are employable for the feature amount calculator M3. For example, the feature amount calculator M3 may use a method called Word2Vec or a method called Glove. The feature amount calculator M3 receives input of a character string and, in response, outputs a feature amount indicating the meaning of the character string. The feature amount, which is expressed in a vector format in this embodiment, may be expressed in any format, for example, expressed in an array format or expressed as a single numerical value.

[3-2. Search Unit]

The search unit 101 is implemented mainly by the control unit 11. The search unit 101 searches the Internet for an image in which a mark to be recognized is shown, with the mark to be recognized as a query. The search itself may use various known search engines including ones that are provided on portal sites and the like. The range of the search may be any range, for example, a range that can be searched from a portal site (the entire Internet) or the range of a specific database, for example, an online shopping mall.

For example, the search unit 101 obtains a character string of a mark input by the administrator from the administrator terminal 30, and executes an image search with the obtained character string as a query. The search unit 101 stores all or some of images that are hits in the search in the mark image database DB2, as mark images, in association with a trademark used in the query. For example, the search unit 101 obtains a given number of images in descending order of scores in the search, and stores the obtained images as mark images in the mark image database DB2. To give another example, images selected at random from search results are stored as mark images in the mark image database DB2. In still another example, the search unit 101 displays search results on the display unit 35 of the administrator terminal 30, and stores images selected by the administrator in the mark image database DB2 as mark images.

It is sufficient for the search unit 101 to store at least one mark image in the mark image database DB2, and may store any number of mark images in the mark image database DB2. For instance, the search unit 101 may store a predetermined number of mark images in the mark image database DB2, or may store all or some of mark images whose scores in the search are equal to or higher than a threshold value in the mark image database DB2. Although a character string of a mark is used as a query in the case described in this embodiment, an image indicating a mark may be used as a query to search for similar images. In this case, only one image may serve as a query, or a plurality of images varied from one another in how light hits the mark, in angle, or in other factors may be used as a query.

[3-3. Mark Recognizer Creation Unit]

The mark recognizer creation unit 102 is implemented mainly by the control unit 11. The mark recognizer creation unit 102 creates the mark recognizer M1 based on a mark image in which a mark to be recognized is shown. The creation of the mark recognizer M1 means an adjustment of a model of the mark recognizer M1, for example, an adjustment of an algorithm or parameter of the mark recognizer M1. In this embodiment, the mark image is found through a search by the search unit 101, and the mark recognizer creation unit 102 accordingly creates the mark recognizer M1 based on the found image.

For example, the mark recognizer creation unit 102 obtains, based on a mark image stored in the mark image database DB2, teacher data in which the mark image or a feature amount thereof is input and a mark shown in the mark image is output. The mark recognizer creation unit 102 has the mark recognizer M1 learn with the obtained teacher data. The learning itself may utilize known methods used in machine learning, and CNN, ResNet, or RNN is an example of usable learning methods. The mark recognizer creation unit 102 creates the mark recognizer M1 so that the input-output relationship indicated by the teacher data is obtained.

[3-4. Classification Recognizer Creation Unit]

The classification recognizer creation unit 103 is implemented mainly by the control unit 11. The classification recognizer creation unit 103 creates the classification recognizer M2 based on an image in which a photographic subject of a classification to be recognized is shown. The creation of the classification recognizer M2 means an adjustment of a model of the classification recognizer M2, for example, an adjustment of an algorithm or parameter of the classification recognizer M2. In this embodiment, a classification image obtained from another system is prepared, and the mark recognizer creation unit 102 accordingly creates the classification recognizer M2 based on the classification image.

For example, the classification recognizer creation unit 103 obtains, based on a classification image stored in the classification image database DB3, teacher data in which the classification image or a feature amount thereof is input and a classification shown in the classification image is output. The mark recognizer creation unit 102 has the mark recognizer M1 learn with the obtained teacher data. The learning itself may utilize known methods used in machine learning, and CNN, ResNet, or RNN is an example of usable learning methods. The classification recognizer creation unit 103 creates the classification recognizer M2 so that the input-output relationship indicated by the teacher data is obtained.

In this embodiment, a plurality of classifications are prepared in advance, and the classification recognizer creation unit 103 accordingly creates the classification recognizer M2 based on pieces of classification information of the plurality of classifications. The classifications are only required to be specified by the administrator, and may be, for example, genres or categories of merchandise carried by an online shopping mall. The classification recognizer creation unit 103 adjusts the classification recognizer M2 so that any one of the pieces of classification information of a plurality of predetermined classifications is output.

[3-5. Feature Amount Calculator Creation Unit]

The feature amount calculator creation unit 104 is implemented mainly by the control unit 11. The feature amount calculator creation unit 104 creates the feature amount calculator M3 configured to calculate the feature amount of a word. The creation of the feature amount calculator M3 means an adjustment of a model of the feature amount calculator M3, for example, an adjustment of an algorithm or parameter of the feature amount calculator M3, or the creation of dictionary data of the feature amount calculator M3.

A known method may be used as the method of creating the feature amount calculator M3 itself and, for example, a method called Word2Vec or a method called Glove may be used. The feature amount calculator creation unit 104 may create the feature amount calculator M3 based on, for example, description text of a legitimate item. A legitimate item is an item for which the estimation unit 109 has yielded an estimation result that is not “fraudulent”. For example, the feature amount calculator creation unit 104 creates the feature amount calculator M3 based on description text stored in the item database DB1.

The feature amount calculator creation unit 104 may obtain a document database from another system, instead of description text stored in the item database DB1, to create the feature amount calculator M3, or may obtain a document database prepared by the administrator to create the feature amount calculator M3. The document database to be used may be any database, for example, articles of a website that provides an encyclopedia, articles of a curation website, or merchandise description text in an online shopping mall.

[3-6. Item Image Obtaining Unit]

The item image obtaining unit 105 is implemented mainly by the control unit 11. The item image obtaining unit 105 obtains an item image in which an item is shown. For example, the item image obtaining unit 105 obtains an item image that is the target of the processing by referring to the item database DB1. It is sufficient for the item image obtaining unit 105 to obtain at least one item image, and the item image obtaining unit 105 may obtain only one item image or a plurality of item images.

The item image is an example of information included in item information. Therefore, “item image” in the description of this embodiment can be read as “item information”. The item information is only required to include information about an item, and may include other types of information than an image, for example, a character string, a chart, a graphic, a moving image, or a sound, or a plurality of types of information selected therefrom.

[3-7. Mark Identification Unit]

The mark identification unit 106 is implemented mainly by the control unit 11. The mark identification unit 106 identifies a mark on an item based on an item image. The identification here is to extract a mark on an item from an item image. The mark identification unit 106 may identify a mark as a character string or an ID, or as an image.

In this embodiment, the mark recognizer M1 is created by the mark recognizer creation unit 102, and the mark identification unit 106 accordingly identifies a mark on an item based on an item image and the mark recognizer M1. The mark identification unit 106 inputs an item image or a feature amount thereof to the mark recognizer M1. The mark recognizer M1 outputs the mark information with which a mark shown in the item image is identified, based on the input item image or feature amount. The mark identification unit 106 identifies the mark on the item by obtaining the output of the mark recognizer M1.

The method of identifying a mark is not limited to the method that uses the mark recognizer M1, and various image analysis technologies may be used. For instance, the mark identification unit 106 may use pattern matching with a sample image to identify a mark on an item from an item image. In this case, a sample image indicating the basic shape of a mark is stored in advance in the data storage unit 100, and the mark identification unit 106 identifies a mark on an item by determining whether an item image has a portion that resembles the sample image. To give another example, the mark identification unit 106 may extract feature points or an outline from an item image to identify a mark on an item based on the pattern of the feature points or of the outline.

[3-8. Position Information Obtaining Unit]

The position information obtaining unit 107 is implemented mainly by the control unit 11. The position information obtaining unit 107 obtains position information about the position of an identified mark in an item image. In this embodiment, the mark recognizer M1 outputs position information about the position of a mark shown in an item image, and the position information obtaining unit 107 obtains the position information output from the mark recognizer M1.

The position information is information indicating the position of an image portion in which a mark is shown out of an item image. In this embodiment, a case in which the position information indicates the position of a bounding box surrounding a mark is described. The position information, however, may indicate the position of any one of pixels indicating a mark, instead of a bounding box. For example, the position information is expressed as coordinate information of two-dimensional coordinate axes set in an item image. It is sufficient to set the two-dimensional coordinate axes with a given point in an item image as the origin. For example, the origin is set in an upper left part of an item image, an X-axis is set in a right direction, and a Y-axis is set in a lower direction.

When a mark is identified by pattern matching and not by the mark recognizer M1, the position information obtaining unit 107 may obtain the position information by identifying a portion of an item image that resembles the sample image. To give another example, the position information obtaining unit 107 may obtain the position information by identifying feature points or outline estimated to be a mark portion of an item image.

[3-9. Classification Identification Unit]

The classification identification unit 108 is implemented mainly by the control unit 11. The classification identification unit 108 identifies the classification of an item based on an item image. The identification here is to determine a classification to which an item shown in an item image belongs, out of a plurality of classifications. The classification identification unit 108 identifies the classification of the item from among a plurality of classifications defined in advance.

In this embodiment, the classification recognizer M2 is created by the classification recognizer creation unit 103, and the classification identification unit 108 accordingly identifies the classification of an item based on an item image and the classification recognizer M2. The classification identification unit 108 inputs an item image or a feature amount thereof to the classification recognizer M2. The classification recognizer M2 outputs the classification information with which the classification of an item shown in the item image is identified, based on the input item image or feature amount. The classification identification unit 108 identifies the classification of the item by obtaining the output of the classification recognizer M2.

In this embodiment, the classification identification unit 108 identifies the classification of an item based also on an item image and the position information. For instance, the classification identification unit 108 performs processing on a portion of an item image that is determined from the position information to identify the classification of an item based on the image subjected to image processing. The processing here is only required to be image processing that reduces or eliminates a feature of a mark portion, and means, for example, masking the mark portion, painting out the mark portion in a given color or the color of the surroundings, or blurring the mark portion. To give another example, the mark portion may be painted out so that, in addition to color, the texture, the shape, and the like blend with the surroundings (so-called content-aware fill).

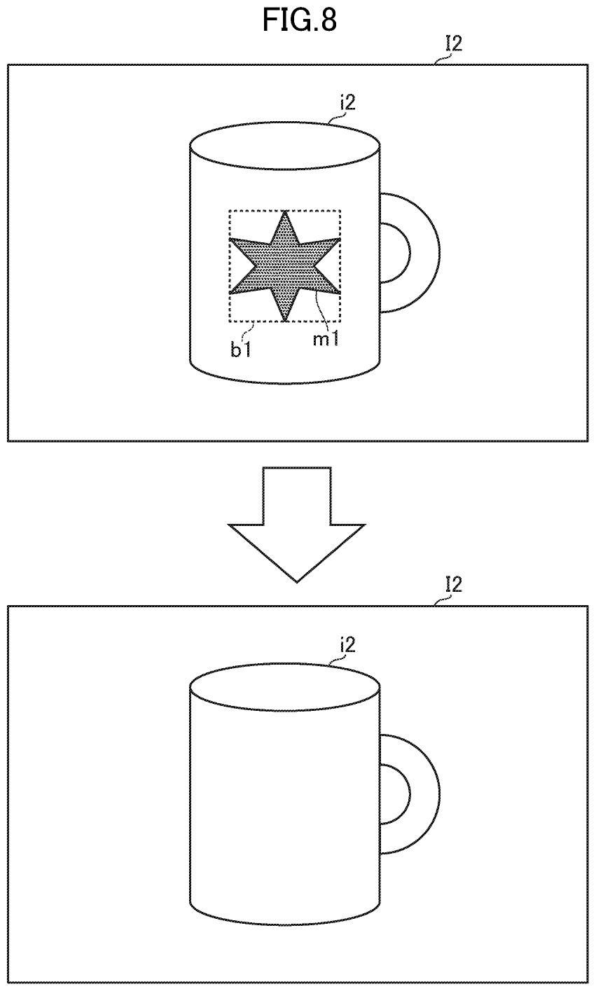

FIG. 8 is a diagram for illustrating how processing is performed on a mark portion of an item image. As illustrated in FIG. 8, the classification identification unit 108 identifies the classification of an item after performing processing, for example, masking, on a bounding box b1, which indicates a mark portion, out of the item image I2. The classification identification unit 108 inputs the processed item image or a feature amount thereof to the classification recognizer M2, and identifies the classification of the item by obtaining output of the classification recognizer M2.

The method of identifying a classification is not limited to the method that uses the classification recognizer M2, and various image analysis technologies may be used. For instance, the classification identification unit 108 may use pattern matching with a sample image to identify the classification of an item from an item image. In this case, the data storage unit 100 stores, in advance, for each classification, a sample image indicating the basic shape of an object that belongs to the classification, and the classification identification unit 108 identifies the classification of an item by determining whether an item image has a portion that resembles the sample image. To give another example, the classification identification unit 108 may extract feature points or an outline from an item image to identify the classification of an item based on the pattern of the feature points or of the outline.

[3-10. Estimation Unit]

The estimation unit 109 is implemented mainly by the control unit 11. The estimation unit 109 estimates fraudulence concerning an item, based on the mark identified by the mark identification unit 106 and the classification identified by the classification identification unit 108. For example, the estimation unit 109 determines whether the combination of the mark and the classification is a reasonable (proper) combination. The estimation unit 109 estimates that there is no fraudulence concerning the item when the combination of the mark and the classification is a reasonable combination, and estimates that there is fraudulence concerning the item when the combination of the mark and the classification is a questionable combination.

The estimation unit 109 also determines, for example, whether a given criterion is fulfilled based on the combination of an item's mark and classification. This criterion is only required to be a determination criterion for whether an item is fraudulent, and a case in which the criterion is about a distance between a feature amount of the mark and a feature amount of the classification is described in this embodiment. The criterion is not limited to the distance between feature amounts, and whether the mark and the classification form a given combination may be determined as in a modification example described later. To give another example, a machine learning model in which a mark and a classification are input and a fraud estimation result is output may be prepared so that the estimation unit 109 estimates fraud with the use of the machine learning model.

In this embodiment, the estimation unit 109 estimates fraudulence concerning an item based on a mark feature amount, which is calculated by the feature amount calculator M3, and a classification feature amount, which is calculated by the feature amount calculator M3. The estimation unit 109 inputs, for example, a character string that indicates the mark identified by the mark identification unit 106 to the feature amount calculator M3 to obtain a feature amount calculated by the feature amount calculator M3. The estimation unit 109 also inputs, for example, a character string that indicates the classification identified by the classification identification unit 108 to the feature amount calculator M3 to obtain a feature amount calculated by the feature amount calculator M3. When the mark information is a character string, the character string is input as it is to the feature amount calculator M3. When the mark information is an ID, the ID is converted into a character string, which is then input to the feature amount calculator M3. Similarly, when the classification information is a character string, the character string is input as it is to the feature amount calculator M3. When the classification information is an ID, the ID is converted into a character string, which is then input to the feature amount calculator M3.

The estimation unit 109 determines whether a difference between the mark feature amount and the classification feature amount is equal to or more than a threshold value. In this embodiment, the feature amounts are expressed in a vector format, and the difference is accordingly a distance in a vector space. When the feature amounts are expressed in another format, the difference may be a numerical value difference. The estimation unit 109 estimates that there is no fraudulence concerning the item when the difference is less than the threshold value, and estimates that there is fraudulence concerning the item when the difference is equal to or more than the threshold value. The estimation unit 109 stores the estimation result in the item database DB1 in association with the item image.

When it is estimated by the estimation unit 109 that there is fraud, processing of any choice may subsequently be executed. For example, a list of item images of items estimated to be fraudulent may be displayed on the administrator terminal 30 so that an item image selected by the administrator is deleted from the server 10. As another example, the administrator may contact a user who has posted an item image of an item estimated to be fraudulent via e-mail or other measures to check about the item. As still another example, an item image of an item estimated to be fraudulent may mandatorily be deleted from the server 10.

### 4. Processing Executed in this Embodiment

Processing executed in this embodiment is described next. The description given here is about preliminary processing for creating the mark recognizer M1, the classification recognizer M2, and the feature amount calculator M3, and estimation processing for estimating fraudulence of an item.

[4-1. Preliminary Processing]

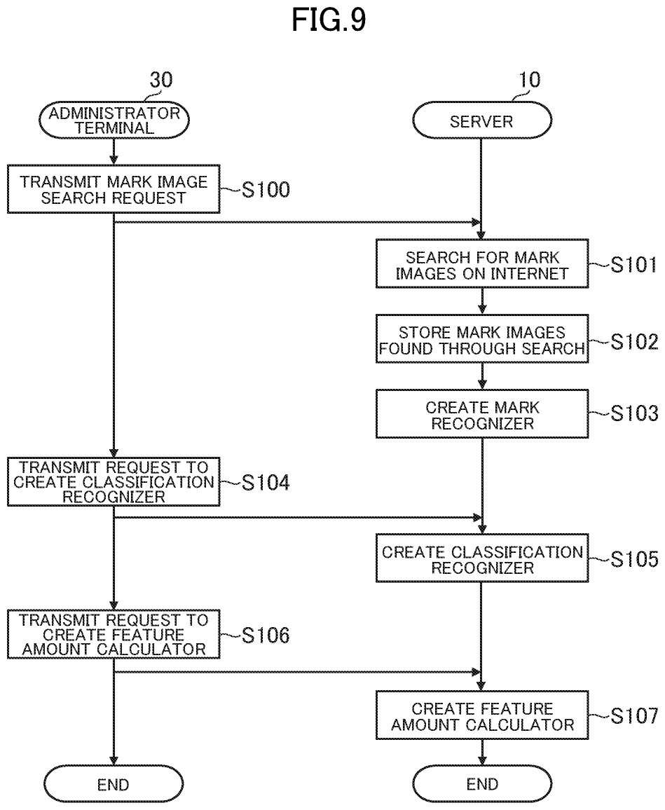

FIG. 9 is a flow chart for illustrating an example of the preliminary processing. The preliminary processing illustrated in FIG. 9 is executed by the control units 11 and 31 operating as programmed by programs that are stored in the storage units 12 and 32. The processing described below is an example of processing that is executed by the function blocks illustrated in FIG. 4. A case in which the mark recognizer M1, the classification recognizer M2, and the feature amount calculator M3 are created by a series of processing procedures is described here. The mark recognizer M1, the classification recognizer M2, and the feature amount calculator M3, however, may be created by processing procedures separate from one another.

As illustrated in FIG. 9, the control unit 31 on the administrator terminal 30 transmits a mark image search request with a mark that is input by the administrator as a query to the server 10 (Step S100). In Step S100, the administrator inputs a character string of a mark to be used as a query from the operation unit 34. The control unit 31 transmits a search request that has, as a query, the character string input by the administrator.

On the server 10, the control unit 11 receives the search request and searches mark images on the internet, with the mark input by the administrator as a query (Step S101). Here, the control unit 11 obtains a given number of mark images that are hits in the search. The control unit 11 may transmit search results to the administrator terminal 30 to receive a selection by the administrator.

The control unit 11 stores the mark images found through the search of Step S101 in the mark image database DB2 (Step S102). In Step S102, the control unit 11 stores the mark input by the administrator and the mark images obtained in Step S101 in the mark image database DB2 in association with each other.

The control unit 11 creates the mark recognizer M1 based on the mark images stored in the mark image database DB2 (Step S103). In Step S103, the control unit 11 creates teacher data in which a mark image or a feature amount thereof is input and the mark input by the administrator is output. The control unit 11 has the mark recognizer M1 learn with the created teacher data.

On the administrator terminal 30, the control unit 31 transmits a request to create the classification recognizer M2 to the server 10 (Step S104). As a way to issue the request to create the classification recognizer M2, the transmission of information in a predetermined format is sufficient. A case in which classification images are stored in advance in the classification image database DB3 is described here. However, the request to create the classification recognizer M2 may include a classification image. To give another example, the server 10 may download classification images from another system when receiving the request to create the classification recognizer M2.

On the server 10, the control unit 11 receives the request to create the classification recognizer M2 and creates the classification recognizer M2 based on classification images stored in the classification image database DB3 (Step S105). In Step S105, the control unit 11 creates teacher data in which a classification image or a feature amount thereof is input and a classification associated with the classification image is output. The control unit 11 has the classification recognizer M2 learn with the created teacher data.

On the management terminal 30, the control unit 31 transmits a request to create the feature amount calculator M3 to the server 10 (Step S106). As a way to issue the request to create the feature amount calculator M3, the transmission of information in a predetermined format is sufficient. A case in which the description text of the item database DB1 is utilized is described here. However, the request to create the feature amount calculator M3 may include document data required to create the feature amount calculator M3. To give another example, the server 10 may download the document data from another system when receiving the request to create the feature amount calculator M3.

On the server 10, the control unit 11 receives the request to create the feature amount calculator M3, and creates the feature amount calculator M3 based on the item database DB1 (Step S107). This processing is then ended. In Step S107, the control unit 11 breaks the description text stored in the item database DB1 into words, and turns each of the words into a feature amount with the use of a function for calculating a feature amount, to thereby create the feature amount calculator M3.

[4-2. Estimation Processing]

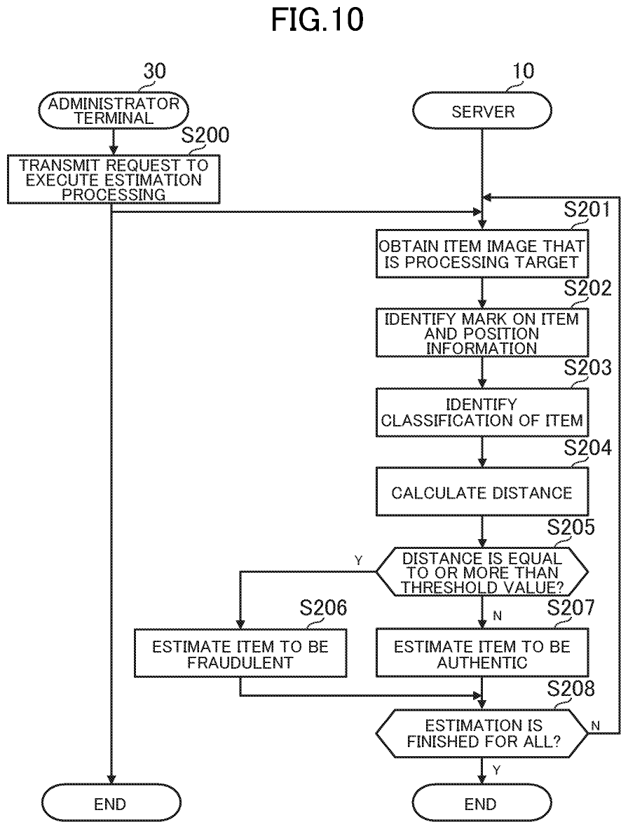

FIG. 10 is a flow chart for illustrating an example of the estimation processing. The estimation processing illustrated in FIG. 10 is executed by the control units 11 and 31 operating as programmed by programs that are stored in the storage units 12 and 32. The processing described below is an example of processing that is executed by the function blocks illustrated in FIG. 4.

As illustrated in FIG. 10, first, the control unit 31 on the administrator terminal 30 transmits a request to execute the estimation processing to the server 10 (Step S200). As a way to issue the request to execute the estimation processing, the transmission of information in a predetermined format is sufficient. A case of processing an item image for which an estimation result is not stored in the item database DB1 is described here. However, the request to execute the estimation processing may include the item ID of an item image that is the target of the processing. The estimation processing may also be executed by timing of any other choice than an instruction from the administrator. For example, the estimation processing may be executed periodically, or may be executed in response to the accumulation of a given number of item images.

On the server 10, the control unit 11 receives the request to execute the estimation processing and obtains the item image that is the target of the processing, based on the item database DB1 (Step S201). In Step S201, the control unit 11 refers to the item database DB1 to obtain any one of item images for which an estimation result is not stored.

The control unit 11 identifies a mark on an item and the position information based on the item image that is the target of the processing and the mark recognizer M1 (Step S202). In Step S202, the control unit 11 inputs the item image or a feature amount thereof to the mark recognizer M1. The mark recognizer M1 outputs the mark information that indicates at least one of a plurality of learned marks, and the position information of the mark, based on the input item image or feature amount. The control unit 11 obtains the output result of the mark recognizer M1. When the mark recognizer M1 does not have the function of outputting the position information of a mark, the control unit 11 may obtain the position information with the use of Grad-CAM or the like.

The control unit 11 identifies the classification of an item based on the item image that is the target of processing, the position information of the mark obtained in Step S202, and the classification recognizer M2 (Step S203). In Step S203, the control unit 11 performs masking, inpainting, or similar processing on an area of the item image that is indicated by the position information. The control unit 11 inputs the item image subjected to the processing or a feature amount thereof to the mark recognizer M1. The mark recognizer M1 outputs the classification information that indicates at least one of a plurality of learned classifications based on the input item image or feature amount. The control unit 11 obtains the classification information output from the mark recognizer M1.

The control unit 11 calculates the distance between a feature amount of the mark identified in Step S202 and a feature amount of the classification identified in Step S203, based on the feature amount calculator M3 (Step S204). In Step S204, the control unit 11 inputs the mark information to the feature amount calculator M3 to obtain the feature amount of the mark. The control unit 11 inputs the classification information to the feature amount calculator M3 to obtain the feature amount of the classification. The control unit 11 calculates the distance between the feature amount of the mark and the feature amount of the classification.

The control unit 11 determines whether the distance between the feature amount of the mark and the feature amount of the classification is equal to or more than a threshold value (Step S205). The threshold value is only required to be a value defined in advance, and may be a fixed value or a variable value. When the threshold value is a variable value, it is sufficient to use a value that is determined based on at least one of the mark and the classification.

When it is determined that the distance is equal to or more than the threshold value (Step S205: Y), the control unit 11 estimates that the item is fraudulent (Step S206). In Step S206, the control unit 11 stores the item's mark information, classification information, and estimation result in the item database DB1 in association with the item image that is the target of the processing.

When it is determined that the distance is less than the threshold value (Step S205: N), on the other hand, the control unit 11 estimates that the item is authentic (Step S207). In Step S207, the control unit 11 stores the item's mark information, classification information, and estimation result in the item database DB1 in association with the item image that is the target of the processing.

The control unit 11 determines, based on the item database DB1, whether estimation has been executed for every item image that is a target of the processing (Step S208). In Step S208, the control unit 11 determines whether there is an item image for which an estimation result is yet to be obtained.

When there is an item image for which estimation has not been executed (Step S208: N), the processing returns to Step S201 to execute the processing on the next item image. When estimation has been executed for every item image (Step S208: Y), on the other hand, this processing is ended.

According to the fraud estimation system S described above, a mark on an item and the classification of the item are identified based on an item image, and fraudulence concerning the item is estimated based on the combination of the mark and the classification, to thereby accomplish fraud estimation from information about an item, without physically attaching a tag to an item and reading the tag. For example, while a method that involves attaching a physical tag to an item as in the related art requires an administrator to read the tag by taking the trouble of visiting a store or the like, the fraud estimation system S enables fraud estimation as long as there is an item image, and consequently accomplishes quick fraud detection. That is, the time from the posting or the like of an item image to the detection of fraud can be shortened. In addition, an administrator or the like is not required to visually determine fraud, and the time and effort to estimate fraudulence of an item can accordingly be lessened. For instance, the administrator can be saved the trouble of visually checking an item image himself/herself to determine fraud because fraud can be estimated from information on an item image and the like even when an actual item is not present.

When a mark on an item is to be identified based on description text of the item or similar information that can be entered freely by the author of a post, it may be difficult to catch fraud because this type of information is easy to fake and is accordingly low in credibility. In this regard, the fraud estimation system S can raise the precision of fraud estimation by identifying a mark on an item based on an item image, which is relatively hard to fake. The fraud estimation system S also enables fraud estimation when description text or similar information does not exist in the first place, as long as there is an item image.

In addition, the fraud estimation system S can raise the precision of mark identification by creating the mark recognizer M1 based on a mark image in which a mark to be recognized is shown, and by identifying a mark on an item based on an item image and the mark recognizer M1. The precision of item fraud estimation can consequently be raised as well.

The fraud estimation system S can also collect mark images more easily and lessen the time and effort to create the mark recognizer M1 by using a mark to be recognized as a query in an Internet search for mark images in which the mark to be recognized is shown, and by creating the mark recognizer M1 based on images found through the search. The use of various mark images on the Internet can also effectively raise the precision of the mark recognizer M1. The precision of item fraud estimation can consequently be raised as well.

When the classification of an item is to be identified based on description text of the item or similar information that can be entered freely by the author of a post, it may be difficult to catch fraud because this type of information is easy to fake and is accordingly low in credibility. In this regard, the fraud estimation system S can raise the precision of fraud estimation by identifying the classification of an item based on an item image, which is relatively hard to fake. The fraud estimation system S also enables fraud estimation when description text or similar information does not exist in the first place, as long as there is an item image.

The fraud estimation system S can also raise the precision of classification identification by creating the classification recognizer M2 based on a classification image in which a photographic subject of a classification to be recognized is shown, and by identifying the classification of an item based on an item image and on the classification recognizer M2. The precision of item fraud estimation can consequently be raised as well.

The fraud estimation system S can also effectively raise the precision of the classification recognizer M2 by identifying the classification of an item from a plurality of classifications that are defined in advance, and by creating the classification recognizer M2 based on a plurality of classifications. The precision of item fraud estimation can consequently be raised as well.

The fraud estimation system S can also raise the precision of classification identification by obtaining position information about the position of a mark in an item image and by identifying the classification of an item based on the item image and the position information.

The fraud estimation system S can also prevent wrong classification due to heavy influence of a mark portion, by estimating the classification after performing processing on a portion of an item image that is determined from the position information. The precision of item fraud estimation can consequently be raised as well.

The fraud estimation system S can also raise the precision of item fraud estimation by creating the feature amount calculator M3 configured to a feature amount of a word and by estimating fraudulence concerning an item based on a feature amount that is calculated for an identified mark with the feature amount calculator M3 and a feature amount that is calculated for an identified classification with the feature amount calculator M3. For example, although it is conceivable to prepare the association between a mark and a classification in advance as in a modification example described later, there is a possibility of a drop in fraud estimation precision when the administrator specifies a wrong association by mistake or accidentally skips the specification of some association in this case. In this regard, a drop in fraud estimation precision can be prevented by estimating fraudulence of an item with the use of a feature amount of a word, which is an objective index.

The fraud estimation system S can also raise the precision of the feature amount calculator M3 by creating the feature amount calculator M3 based on description text of a legitimate item. The precision of the feature amount calculator M3 can be raised by excluding, for example, description text of a fraudulent item, which may be false text intentionally entered by a malicious user. The precision of item fraud estimation can consequently be raised as well.

### 5. Modification Example

The one embodiment of the present invention is not limited to the embodiment described above. The one embodiment of the present invention can suitably be modified without departing from the spirit of the one embodiment of the present invention.

(1) For instance, the method for fraud estimation by the estimation unit 109 is not limited to the example described in the embodiment. It is sufficient for the estimation unit 109 to determine whether the combination of an item's mark and classification is reasonable and, for example, reasonable combinations or questionable combinations of an item's mark and classification may be prepared in advance.

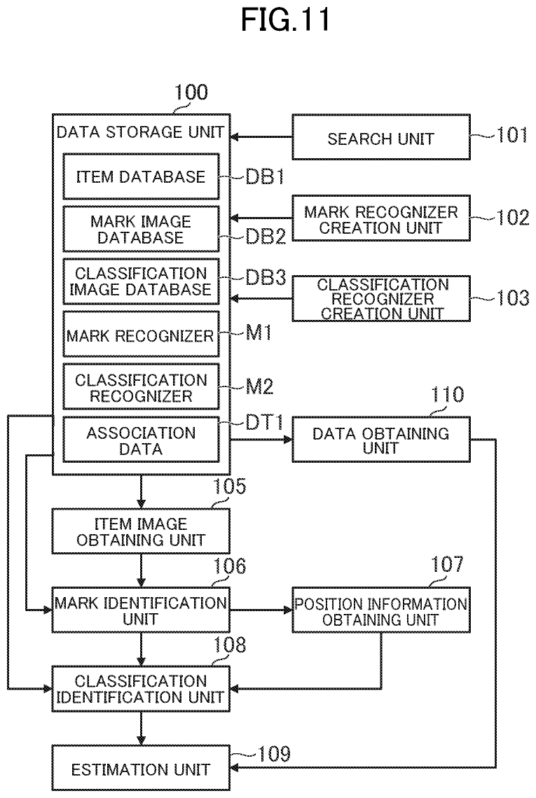

FIG. 11 is a function block diagram in Modification Example (1). As illustrated in FIG. 11, in Modification Example (1), the data storage unit 100 stores association data DT1, and a data obtaining unit 110 is implemented in addition to the functions described in the embodiment. The data obtaining unit 110 is implemented mainly by the control unit 11. In Modification Example (1), the data storage unit 100 may not store the feature amount calculator M3 and the fraud estimation system S may not include the feature amount calculator creation unit 104.

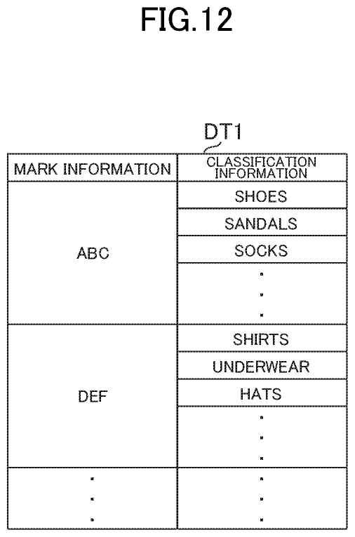

FIG. 12 is a table for showing a data storage example of the association data DT1. As shown in FIG. 12, the mark information of each of a plurality of marks and the classification information of at least one classification are stored in the association data DT1. In other words, at least one piece of classification information is stored for each piece of mark information in the association data DT1. A case in which reasonable combinations of a mark and a classification are defined in the association data DT1 is described here. However, questionable combinations of a mark and a classification may be defined in the association data DT1.

The administrator prepares the association data DT1 in the case described here. However, the association data DT1 may be generated automatically by taking the statistics of the item database DB1. For example, the administrator identifies a reasonable combination of a mark and a classification by using a catalog, website, or the like of the manufacturer of an item. The administrator inputs the identified combination from the operation unit 34 of the administrator terminal 30 to create the association data DT1, and uploads the association data DT1 to the server 10. The server 10 receives the association data DT1 uploaded by the administrator, and stores the association data DT1 in the data storage unit 100.

The data obtaining unit 110 obtains the association data DT1 in which each of a plurality of marks is associated with at least one classification. In this modification example, the association data DT1 is stored in the data storage unit 100, and the data obtaining unit 110 accordingly obtains the association data DT1 stored in the data storage unit 100.

The estimation unit 109 estimates fraudulence concerning an item based on an identified mark, an identified classification, and the association data DT1. For example, when reasonable combinations of a mark and a classification are defined in the association data DT1, the estimation unit 109 determines whether the combination of an item's mark and classification is found in the association data DT1. The estimation unit 109 estimates that there is no fraudulence concerning the item when the combination of the item's mark and classification is found in the association data DT1, and estimates that there is fraudulence concerning the item when the combination of the item's mark and classification is not found in the association data DT1.

When questionable combinations of a mark and a classification are defined in the association data DT1, the estimation unit 109 estimates that there is no fraudulence concerning an item when the combination of the item's mark and classification is not found in the association data DT1, and estimates that there is fraudulence concerning the item when the combination of the item's mark and classification is found in the association data DT1.

According to Modification Example (1), the time and effort to estimate fraud can be lessened by estimating fraudulence concerning an item based on an identified mark, an identified classification, and the association data DT1. For example, while the method described in the embodiment requires the server 10 to create the feature amount calculator M3 and to calculate a feature amount, the method of Modification Example (1) does not require the execution of such processing, and accordingly accomplishes fraud estimation with simple processing, which can lighten the processing load on the server 10 as well.

(2) To give another example, the fraud estimation system S is applicable to any other scene than the case described in the embodiment, in which fraudulence concerning an item is estimated based on an item image that is posted on a social network, a bulletin board, or the like. For example, the fraud estimation system S may be used in a scene in which fraudulence concerning a product that is listed on an online shopping mall is determined.

In this modification example, the server 10 manages the website of an online shopping mall. A user operating the user terminal 20 is a staff member or the like of a store selling on the online shopping mall. The user uploads product information about a product carried by his/her store to the server 10. The item database DB1 stores an item ID with which a product sold by the store is uniquely identified, an item image that is a product image, description text of the product, mark information with which a mark identified by the mark recognizer M1 is identified, classification information with which a classification identified by the classification recognizer M2 is identified, and an estimation result by the estimation unit 109. A product page for purchasing the product is displayed based on those pieces of information.

In this modification example, an item is a product and item information is product information about a product. The product may be any object of transaction on online shopping malls. The product information may be any type of basic information about the product, and is only required to be information entered by the user, who is a staff member or the like of the store.

The mark identification unit 106 identifies a mark on the product based on the product information, and the classification identification unit 108 identifies the classification of the product based on the product information. The method of identifying the mark and the method of identifying the classification themselves are as described in the embodiment. The estimation unit 109 estimates fraudulence concerning the product. The method for fraud estimation to be employed may be the method described in the embodiment or the method described in Modification Example (1). When an item is estimated to be fraudulent, the administrator prevents the page for purchasing the item from being displayed or imposes a penalty on the store selling the item, for example.

The item database DB1 may store other pieces of information, for example, classification information that is specified by the store to identify the classification of the product, the title of the product, the price of the product, and the inventory of the product. In this case, the classification identification unit 108 may identify the classification of the product by referring to the classification information that is specified by the store, without using the classification recognizer M2. Similarly, the mark identification unit 106 may identify the mark from the description text or title of the product.

According to Modification Example (2), the sale of a fraudulent item can be prevented through estimation of fraudulence concerning a product by identifying a mark on the product and the classification of the product based on the product information.

(3) To give another example, the item information may be other types of information than an item image, which is described as an example of the item information in the embodiment, and may be a character string, a moving image, or a sound. When the item information is a character string, for example, the mark identification unit 106 may identify a mark by determining whether a character string that is associated with an item includes a character string that indicates the mark. In this case, the position information indicates the position of the character string of the mark in the entire text. The classification identification unit 108 may identify a classification by determining whether the character string that is associated with the item includes a character string that indicates the classification, or by referring to classification information that is associated with the item. As another example, the classification identification unit 108 may identify the classification of the item after hiding the character string of the mark portion, which is indicated by the position information.

When the item information is a moving image, for example, the mark identification unit 106 and the classification identification unit 108 may identify a mark and a classification, respectively, by using the methods that are described in the embodiment or the modification examples on each of individual images that form the moving image. When the item information is a sound, for example, a mark is a sound used in a commercial or the like. The mark identification unit 106 identifies a mark by analyzing the sound of the item information and determining whether a waveform that indicates the mark has been obtained. The classification identification unit 108 may identify a classification by analyzing the sound or, when another type of information, for example, a character string or an image, is available, may identify a classification by referring to the other type of information.

To give another example, the mark identification unit 106 may refer to the item image to identify a mark while the classification identification unit 108 refers to the description text or the classification information to identify a classification, so that a mark and a classification are identified with reference to separate pieces that are included in the item information.

To give another example, the main functions, which are implemented by the server 10 in the case described above, may be divided among a plurality of computers. The functions may be divided among, for example, the server 10, the user terminal 20, and the administrator terminal 30. For example, the classification and similar processing may be executed by the user terminal 20 or the administrator terminal 30 instead of the server 10. When the fraud estimation system S includes a plurality of server computers, for example, the functions may be divided among the plurality of server computers. To give still another example, the data that is stored in the data storage unit 100 in the description given above may be stored on a computer other than the server 10.

The invention claimed is:

1: A fraud estimation system, comprising at least one processor configured to:
obtain item information about an item;
identify a mark on the item, based on the item information;
identify a classification of the item, based on the item information; and
estimate fraudulence concerning the item, based on the identified mark and the identified classification.

2: The fraud estimation system according to claim 1,
wherein the item information includes an item image in which the item is shown, and
wherein the at least one processor is configured to identify the mark on the item based on the item image.

3: The fraud estimation system according to claim 2, wherein the at least one processor is configured to create a mark recognizer, based on an image in which a mark to be recognized is shown, and
wherein the at least one processor is configured to identify the mark on the item, based on the item image and the mark recognizer.

4: The fraud estimation system according to claim 3, wherein the at least one processor is configured to search the Internet for the image in which the mark to be recognized is shown, with the mark to be recognized as a query, and
wherein the at least one processor is configured to create the mark recognizer, based on the image that is found through the search.

5: The fraud estimation system according to claim 1,
wherein the item information includes an item image in which the item is shown, and
wherein the at least one processor is configured to identify the classification of the item, based on the item image.

6: The fraud estimation system according to claim 5, wherein the at least one processor is configured to create a classification recognizer, based on an image in which a photographic subject of a classification to be recognized is shown, and
wherein the at least one processor is configured to identify the classification of the item, based on the item image and the classification recognizer.

7: The fraud estimation system according to claim 6,
wherein the at least one processor is configured to identify the classification of the item from among a plurality of classifications defined in advance, and
wherein the at least one processor is configured to create the classification recognizer, based on the plurality of classifications.

8: The fraud estimation system according to claim 5,
wherein the at least one processor is configured to identify the mark on the item, based on the item image,
wherein the at least one processor is configured to obtain position information about a position of the identified mark in the item image, and
wherein the at least one processor is configured to identify the classification of the item, based on the item image and the position information.

9: The fraud estimation system according to claim 8, wherein the at least one processor is configured to perform processing on a portion of the item image that is determined from the position information to identify the classification of the item, based on the image that has been subjected to the processing.

10: The fraud estimation system according to claim 1, wherein the at least one processor is configured to create a feature amount calculator configured to calculate a feature amount of a word, and
wherein the at least one processor is configured to estimate fraudulence concerning the item, based on a feature amount that is calculated for the identified mark by the feature amount calculator and a feature amount that is calculated for the identified classification by the feature amount calculator.

11: The fraud estimation system according to claim 10, wherein the at least one processor is configured to create the feature amount calculator, based on description text of a legitimate item.

12: The fraud estimation system according to claim 1, wherein the at least one processor is configured to obtain association data, in which each of a plurality of marks is associated with at least one classification,
wherein the at least one processor is configured to estimate fraudulence concerning the item, based on the identified mark, the identified classification, and the association data.

13: The fraud estimation system according to claim 1,
wherein the item is a product,
wherein the item information is product information about the product,
wherein the at least one processor is configured to identify a mark on the product, based on the product information,
wherein the at least one processor is configured to identify a classification of the product, based on the product information, and
wherein the at least one processor is configured to estimate fraudulence concerning the product.

14: A fraud estimation method, comprising:
obtaining item information about an item;
identifying a mark on the item, based on the item information;
identifying a classification of the item, based on the item information; and
estimating fraudulence concerning the item, based on the identified mark and the identified classification.

15: A non-transitory computer-readable information storage medium for storing a program for causing a computer to:
obtain item information about an item;
identify a mark on the item, based on the item information;
identify a classification of the item, based on the item information; and
estimate fraudulence concerning the item, based on the identified mark and the identified classification.
